(19) United States
(12) Patent Application Publication
(10) Pub. No.: US 2026/0037229 A1
(43) Pub. Date: Feb. 5, 2026

(54) STRUCTURING SUPPORT DEVICE, STRUCTURING SUPPORT METHOD, AND COMPUTER READABLE MEDIUM

(71) Applicant: Mitsubishi Electric Corporation, Tokyo (JP)

(72) Inventor: Ryota HASHIMOTO, Tokyo (JP)

(73) Assignee: Mitsubishi Electric Corporation, Tokyo (JP)

(21) Appl. No.: 19/354,995

(22) Filed: Oct. 10, 2025

Related U.S. Application Data
(63) Continuation of application No. PCT/JP2023/020727, filed on Jun. 2, 2023.

(51) Int. Cl. G06F 8/30

(52) U.S. Cl. CPC G06F 8/30

(57) ABSTRACT

A structuring support device (10) sets each of one or more variables used in a plurality of similar program blocks contained in a latter program as a target variable. The structuring support device (10) determines a type of the target variable in accordance with whether or not a condition is met that the target variable is not used outside a plurality of program blocks in the ladder program and is commonly used in the plurality of program blocks. Based on the determined type, the structuring support device (10) generates a function block obtained by functionalizing the plurality of program blocks.

### CROSS REFERENCE TO RELATED APPLICATIONS

This application is a Continuation of PCT International Application No. PCT/JP2023/020727 filed on Jun. 2, 2023, all of which is hereby expressly incorporated by reference into the present application.

### TECHNICAL FIELD

The present disclosure relates to a technology that supports structuring of a ladder program.

### BACKGROUND ART

Even in a ladder program for a programmable logic controller, structuring has been promoted. In a program creation support tool for ladder programs, there is a demand for a feature that supports structuring of ladder programs. The structuring of a ladder program includes function blocking which means functionalizing of a feature.

Patent Literature 1 describes a technology which, when a user specifies a range of a program they want to function-block, performs function blocking of the specified range. In function blocking, it is necessary to convert a variable such as a device and a label used in the selected range into a variable of an appropriate type and then to perform function blocking. In Patent Literature 1, a variable is converted into a variable of a type such as an input/output variable and an internal variable in accordance with whether or not the variable is used outside the specified range.

### CITATION LIST

### Patent Literature

Patent Literature 1: JP 2008-33913 A

### SUMMARY OF INVENTION

### Technical Problem

A code clone detection technology is available that detects similar programs. When function-blocking similar programs extracted by the code clone technology and the like, it is necessary to make a plurality of programs into one function block. However, with the technology described in Patent Literature 1, when a plurality of programs are function-blocked simultaneously, there is a possibility that a variable such as a device and a label cannot be converted into a variable of an appropriate type.

An objective of the present disclosure is to enable conversion into an appropriate variable when making a plurality of programs into one function block.

### Solution to Problem

A structuring support device according to the present disclosure includes:
a program analysis unit to identify a plurality of similar program blocks contained within a ladder program; and
a function block generation unit to set each of one or more variables used in the plurality of program blocks identified by the program analysis unit as a target variable, determine a type of the target variable in accordance with whether or not a condition is met that the target variable is not used outside the plurality of program blocks in the ladder program and is commonly used in the plurality of program blocks in the ladder program, and generate a function block obtained by functionalizing the plurality of program blocks.

### Advantageous Effects of Invention

In the present disclosure, the type of a target variable is determined in accordance with whether or not a condition is met that the target variable is not used outside a plurality of program blocks and is commonly used in the plurality of program blocks. As a result, the type of the variable can be appropriately determined and the variable can be converted into an appropriate variable.

### BRIEF DESCRIPTION OF DRAWINGS

FIG. 1 is a schematic diagram of a structuring support device 10 according to Embodiment 1.

FIG. 2 is a flowchart of processing of the structuring support device 10 according to Embodiment 1.

FIG. 3 is a diagram illustrating an example of a ladder program 30 according to Embodiment 1.

FIG. 4 is an explanatory diagram of a variable analysis process according to Embodiment 1.

FIG. 5 is a flowchart of a variable type determination process according to Embodiment 1.

FIG. 6 is an explanatory diagram of the variable type determination process according to Embodiment 1.

FIG. 7 is an explanatory diagram of a generation process of a function block 32 according to Embodiment 1.

FIG. 8 is an explanatory diagram of a program conversion process according to Embodiment 1.

FIG. 9 is a schematic diagram of a structuring support device 10 according to Modification 1.

FIG. 10 is a schematic diagram of a structuring support device 10 according to Embodiment 2.

FIG. 11 is a flowchart of processing of the structuring support device 10 according to Embodiment 2.

FIG. 12 is an explanatory diagram of a program comparison process according to Embodiment 2.

### DESCRIPTION OF EMBODIMENTS

### Embodiment 1

### Description of Configuration

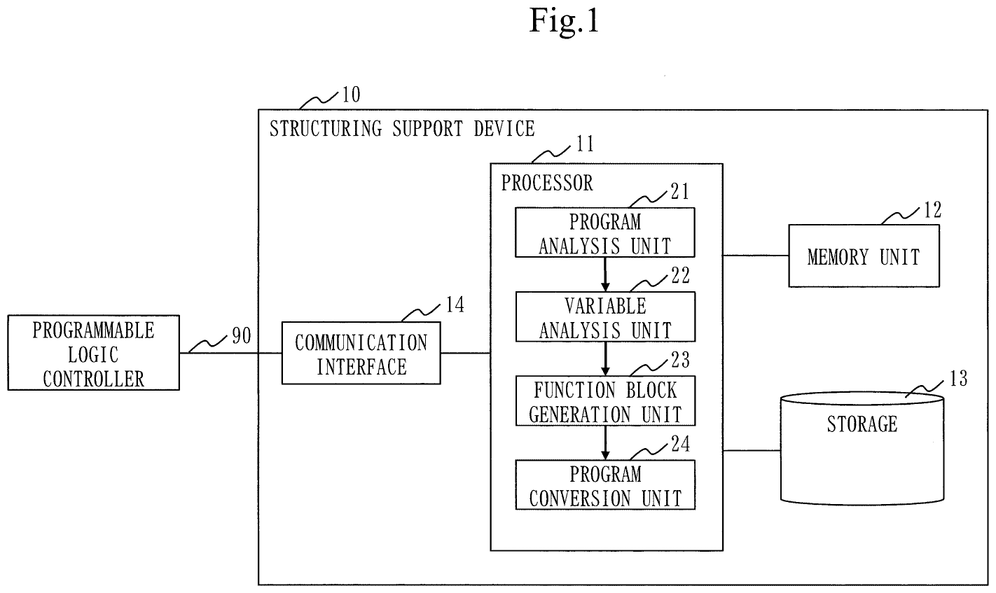

Referring to FIG. 1, a configuration of a structuring support device 10 according to Embodiment 1 will be described.

The structuring support device 10 is a computer that supports structuring of a ladder program by analyzing and function-blocking the ladder program.

The structuring support device 10 includes hardware devices such as a processor 11, a memory unit 12, a storage 13, and a communication interface 14. The processor 11 is connected to the other hardware devices via a signal line, and controls the other hardware devices.

The processor 11 is an IC that performs processing. IC stands for Integrated Circuit. The processor 11 is, for instance, a CPU, DSP, or GPU. CPU stands for Central Processing Unit. DSP stands for Digital Signal Processor. GPU stands for Graphics Processing Unit.

The memory unit 12 is a storage device used to temporarily store data. Specifically, the memory unit 12 can be, for example, an SRAM or a DRAM. SRAM stands for Static Random Access Memory. DRAM stands for Dynamic Random Access Memory.

The storage 13 is a storage device for storing data. Specifically, as an example, storage 13 could be an HDD. HDD stands for Hard Disk Drive. In addition, the storage 13 could also be a portable recording medium such as an SD (registered trademark) memory card, a CompactFlash (registered trademark), a NAND flash, a flexible disk, an optical disc, a compact disc, a Blu-ray (registered trademark) disc, and a DVD. SD stands for Secure Digital. DVD stands for Digital Versatile Disk.

The communication interface 14 is an interface for communication with external devices. The communication interface 14 is, for example, an Ethernet (registered trademark) port, a USB port, or an HDMI (registered trademark) port. USB stands for Universal Serial Bus. HDMI stands for High-Definition Multimedia Interface.

The structuring support device 10 is connected via the communication interface 14 to a transmission path 90 to which a programmable logic controller is connected. The transmission path 90 is a network such as a bus or LAN, as a specific example. LAN stands for Local Area Network.

The structuring support device 10 includes, as feature constituent elements, a program analysis unit 21, a variable analysis unit 22, a function block generation unit 23, and a program conversion unit 24. The features of the feature constituent elements of the structuring support device 10 are implemented by software.

In the storage 13, a program that realizes the features of the feature constituent elements of the structuring support device 10 is stored. This program is read into the memory unit 12 by the processor 11, and executed by the processor 11. As a result, the features of the feature constituent elements of the structuring support device 10 are realized.

In FIG. 1, as the processor 11, only one is shown. However, there can be a plurality of processors 11, and the plurality of processors 11 could work together to execute programs that implement various features.

### Description of Operation

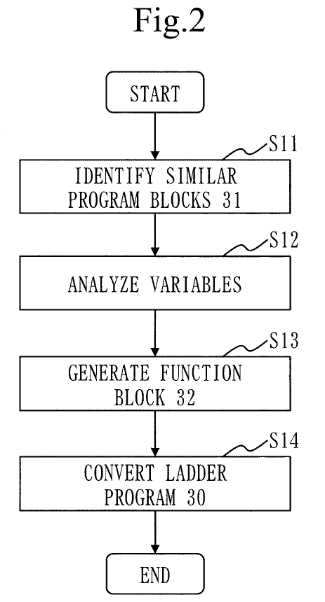

Referencing to FIG. 2 through FIG. 8, the operation of the structuring support device 10 according to Embodiment 1 will be described.

An operating procedure of the structuring support device 10 according to Embodiment 1 corresponds to a structuring support method according to Embodiment 1. Additionally, a program that realizes the operation of the structuring support device 10 according to Embodiment 1 corresponds to a structuring support program according to Embodiment 1.

Referring to FIG. 2, a flow of processing of the structuring support device 10 according to Embodiment 1 will be described.

### (Step S11: Program Analysis Process)

The program analysis unit 21 analyzes a ladder program 30 to identify a plurality of similar program blocks 31 contained within the ladder program 30. The program blocks 31 are program portions that constitute the ladder program 30.

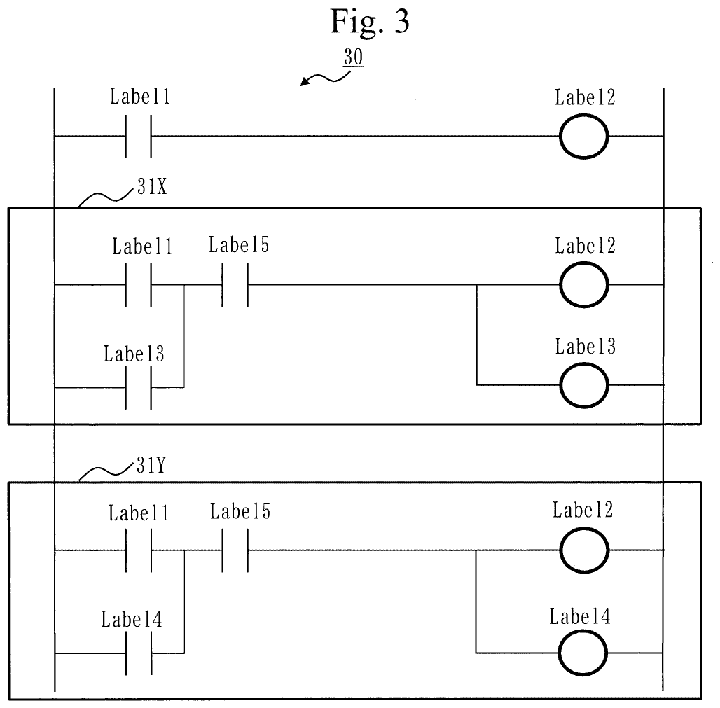

The ladder program 30 is constructed using a variable such as a device and a label. In FIG. 3, the ladder program 30 is constructed using five variables, Label 1 to Label 5. The program analysis unit 21 uses techniques such as code clone detection technology to identify the plurality of similar program blocks 31 from the ladder program 30. Being similar signifies that, for instance, the program blocks 31 have the same structure but use different variables. Any method is acceptable as far as it can identify the similar program blocks 31. In FIG. 3, a program block 31X and a program block 31Y are identified as similar program blocks 31.

### (Step S12: Variable Analysis Process)

The variable analysis unit 22 analyzes the variables used in the plurality of program blocks 31 identified in step S11.

Specifically, the variable analysis unit 22 sets each of one or more variables used in the plurality of program blocks 31 as a target variable. The variable analysis unit 22 identifies a place of use and a situation of use for the target variable.

The place of use includes the following three: input, output, and input/output. Input signifies a case where the target variable is used in an input command. Output signifies a case where the target variable is used in an output command. Input/output signifies a case where the target variable is used in an input command and an output command.

The situation of use includes three situations: (1) to (3). (1) signifies a case where the variable is used outside the plurality of program blocks 31 in the ladder program 30. (2) signifies a case where the target variable is not used outside the plurality of program blocks 31 in the ladder program 30 and is not commonly used in the plurality of program blocks 31 in the ladder program 30. (3) signifies a case where the target variable is not used outside the plurality of program blocks 31 in the ladder program 30 and is commonly used in the plurality of program blocks 31 in the ladder program 30.

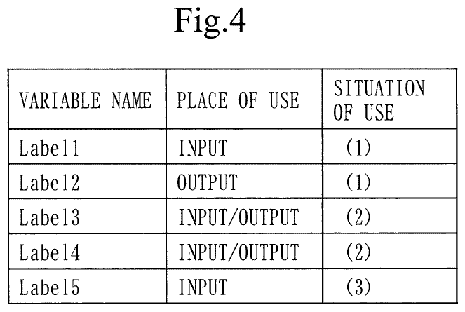

As a result, the variables used in the ladder program 30 shown in FIG. 3 are analyzed as shown in FIG. 4.

In FIG. 3, Label 1 and Label 2 are used outside the plurality of program blocks 31, which corresponds to (1). Label 3 and Label 4 are not used outside the plurality of program blocks 31 while Label 3 is used only in the program block 31X and Label 4 is used only in the program block 31Y, which corresponds to (2). Label 5 is not used outside the plurality of program blocks 31 and is used commonly in the program blocks 31X and 31Y, which corresponds to (3).

### (Step S13: Function Block Generation Process)

The function block generation unit 23 determines a type of variable by referring to an analysis result obtained in step S12. Then, based on the type of variable, the function block generation unit 23 generates a function block 32 obtained by functionalizing the plurality of program blocks.

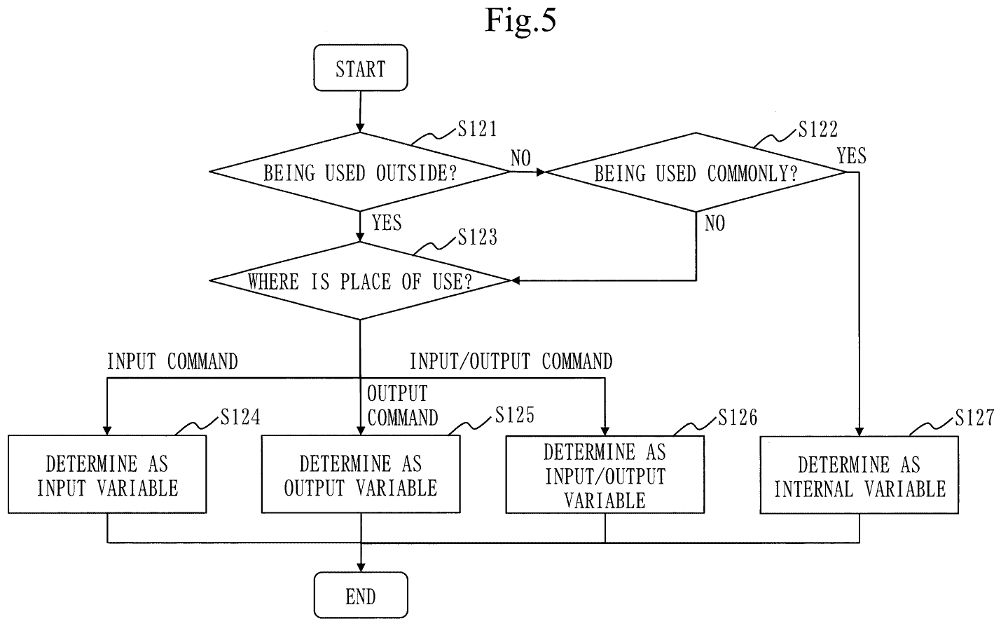

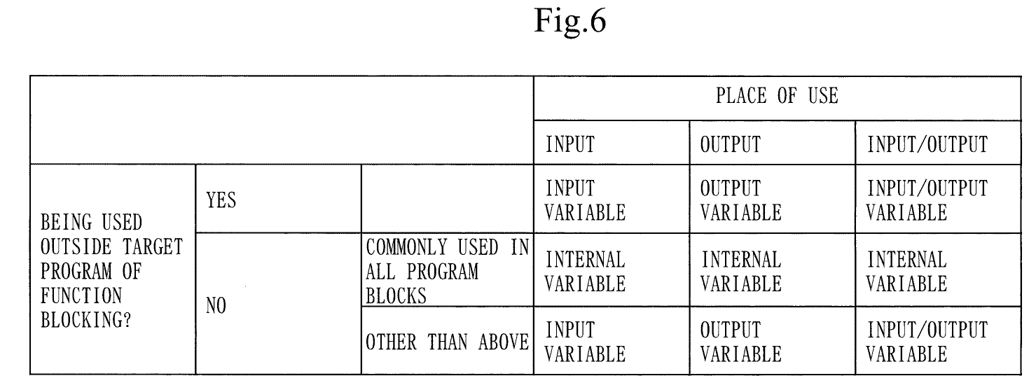

Referring to FIG. 5 and FIG. 6, a variable type determination process will be described.

The function block generation unit 23 sets one or more variables used in the plurality of program blocks 31 as the target variable. Then, the function block generation unit 23 executes the process shown in FIG. 5 for the target variable.

### (Step S121: External Use Judgment Process)

The function block generation unit 23 judges whether or not the target variable is being used outside the plurality of program blocks 31 in the ladder program 30. If the target variable is not used externally, the function block generation unit 23 proceeds to step S122. On the other hand, if the target variable is used externally, the function block generation unit 23 proceeds to step S123.

### (Step S122: Common Specification Judgment Process)

The function block generation unit 23 judges whether or not the target variable is commonly used in the plurality of program blocks 31. If the target variable is not commonly used, the function block generation unit 23 proceeds to step S123. On the other hand, if the target variable is commonly used, the function block generation unit 23 proceeds to step S127.

### (Step S123: Command Judgment Process)

The function block generation unit 23 judges in which one between an input command and an output command the target variable is being used. If the target variable is being used in an input command, the function block generation unit 23 proceeds to step S124. If the target variable is being used in an output command, the function block generation unit 23 proceeds to step S125. If the target variable is being used in an input command and an output command, the function block generation unit 23 proceeds to step S126.

### (Step S124: First Determination Process)

The function block generation unit 23 determines to use the type of the target variable as an input variable.

### (Step S125: Second Determination Process)

The function block generation unit 23 determines to use the type of the target variable as an output variable.

### (Step S126: Third Decision Process)

The function block generation unit 23 determines to use the type of the target variable as an input/output variable.

### (Step S127: Fourth Determination Process)

The function block generation unit 23 determines to use the type of the target variable as an internal variable.

Therefore, Label 1 is an input variable, Label 2 is an output variable, Label 3 and Label 4 each are an input/output variable, and Label 5 is an internal variable.

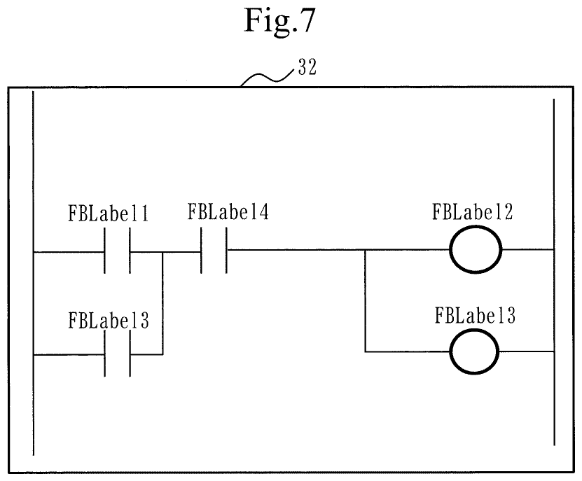

Referring to FIG. 7, a generation process of the function block 32 will be described.

The function block generation unit 23 selects one program block 31 out of the plurality of program blocks 31. The function block generation unit 23 sets a variable name in the function block 32 for each variable in the selected program block 31, along with setting the determined type.

Assume that the program block 31X in FIG. 3 is selected. In this case, FBLabel 1 is set as the name for Label 1, and input variable is set as the type. FBLabel 2 is set as the name for Label 2, and output variable is as the type for Label 2. FBLabel 3 is set as the name for Label 3, and input/output variable is set as the type. FBLabel 4 is set as the name for Label 5, and an internal variable is set as the type. As a result, a function block 32 is generated.

Assume that the program block 31Y in FIG. 3 is selected. In this case, FBLabel 1 is set as the name for Label 1, and input variable is set as the type. FBLabel 2 is set as the name for Label 2, and output variable is set as the type. FBLabel 3 is set as the name for Label 4, and input/output variable is set as the type. FBLabel 4 is set as the name for Label 5, and internal variable is set as the type. As a result, a function block 32 that is the same as that generated when the program block 31X was selected is generated.

### (Step S14: Program Conversion Process)

The program conversion unit 24 converts the ladder program 30 by replacing the plurality of program blocks 31 with the function block 32 generated in step S13. Replacing the program block 31 with the function block 32 can be done with any method as long as it guarantees that the ladder program 30 remains equivalent before and after the replacement.

For example, the program conversion unit 24, for each program block 31 in the ladder program 30, while leaving an input command from the outside and an output command to the outside as they are, replaces the remaining part with the function block 32. In this case, the program conversion unit 24 associates a variable used in the remaining input command with a corresponding variables in the function block 32.

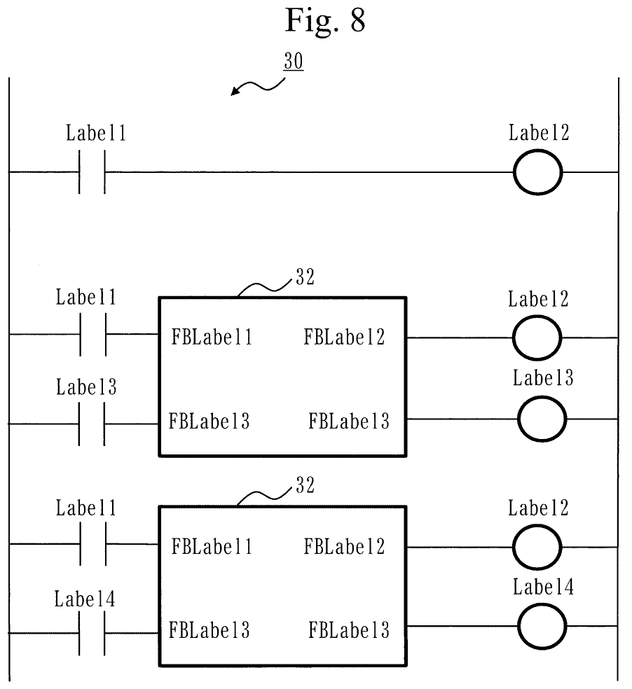

In the case of the ladder program 30 shown in FIG. 3, the program blocks 31X and 31Y are replaced with function blocks 32, as shown in FIG. 8.

Regarding the program block 31X, the input commands Label 1 and Label 3 which are input commands from the outside, and output commands Label 2 and Label 3 which are output commands to the outside are left, with the rest being replaced with the function block 32. Then, the input command of Label 1 is associated with FBLabel 1, Label 2 is associated with FBLabel 2, and Label 3 is associated with FBLabel 3.

Regarding the program block 31Y, the input commands Label 1 and Label 4 which are input commands from the outside, and output commands Label 2 and Label 4 which are output commands to the outside are left, with the rest being replaced with the function block 32. Then, the input command of Label 1 is associated with FBLabel 1, Label 2 is associated with FBLabel 2, and Label 4 is associated with FBLabel 3.

### Effects of Embodiment 1

As stated above, the structuring support device 10 according to Embodiment 1 determines the type of the target variable in accordance with whether or not a condition is met that the target variable is not used outside a plurality of program blocks and is commonly used in the plurality of program blocks. As a result, the type of the variable can be appropriately determined and the variable can be converted into an appropriate variable. Therefore, it is possible to reduce the man-hours required when structuring the ladder program.

### Other Configurations

### Modification 1

In Embodiment 1, the feature constituent elements were implemented by software. However, in Modification 1, feature constituent elements may be implemented by hardware. Differences in Modification 1 from Embodiment 1 will be described.

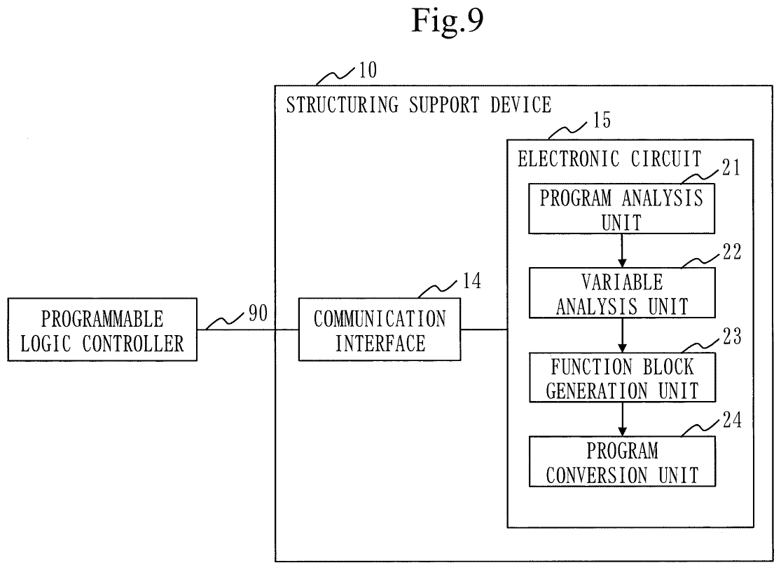

Referring to FIG. 9, a configuration of a structuring support device 10 according to Modification 1 will be described.

When the feature constituent elements are implemented by hardware, the structuring support device 10 is provided with an electronic circuit 15 instead of a processor 11, a memory unit 12, and a storage 13. The electronic circuit 15 is a dedicated circuit that realizes the features of the feature constituent elements, of the memory unit 12, and of the storage 13.

The electronic circuit 15 may be envisioned as a single circuit, a composite circuit, a programed processor, a parallel-programmed processor, a logic IC, a GA, an ASIC, or an FPGA. GA is short for Gate Array. ASIC is short for Application Specific Integrated Circuit. FPGA is short for Field-Programmable Gate Array.

The feature constituent elements may be realized by a single electronic circuit 15 or distributed among and realized as a plurality of electronic circuits 15.

### Modification 2

As Modification 2, some of the feature constituent elements may be implemented by hardware, while the other feature constituent elements may be implemented by software.

The processor 11, the memory unit 12, the storage 13, and the electronic circuit 15 are collectively referred to as processing circuitry. In other words, the features of the feature constituent elements are realized by processing circuitry.

### Embodiment 2

What distinguishes Embodiment 2 from Embodiment 1 is that in Embodiment 2 a function block 32 that is the same as the existing function block 32 is not generated. In Embodiment 2, this difference will be described while an explanation for the same points will be omitted.

### Description of Configuration

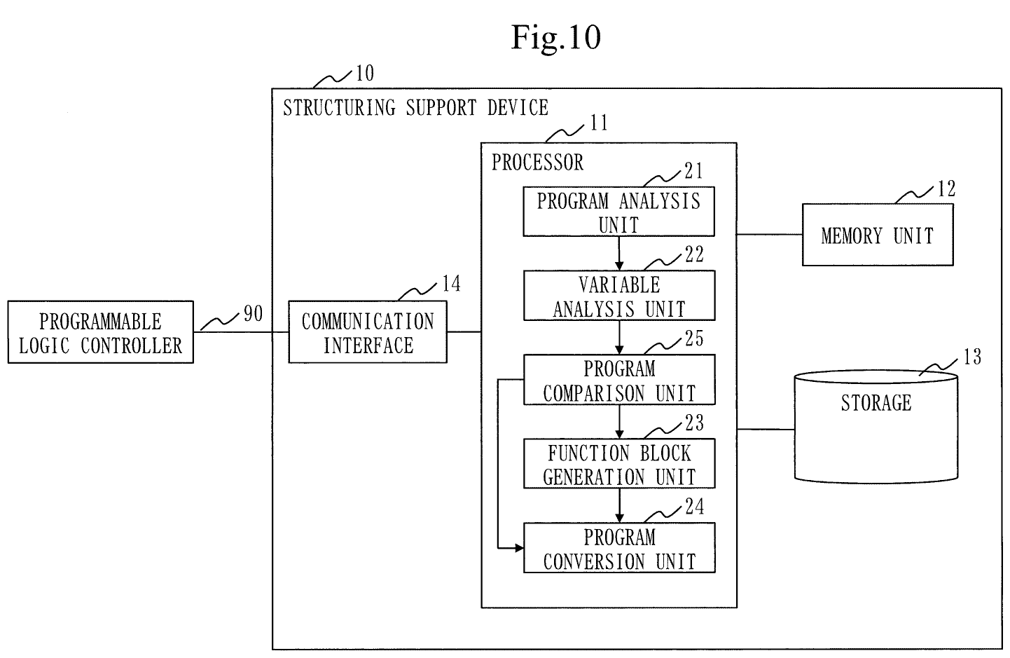

Referring to FIG. 10, a configuration of a structuring support device 10 according to Embodiment 2 will be described.

The structuring support device 10, different from the structuring support device 10 shown in FIG. 1, includes a program comparison unit 25 as a feature constituent element. A feature of the program comparison unit 25 and a feature of the storage part 26 are implemented by software or hardware, just as with the other feature constituent elements.

### Description of Operation

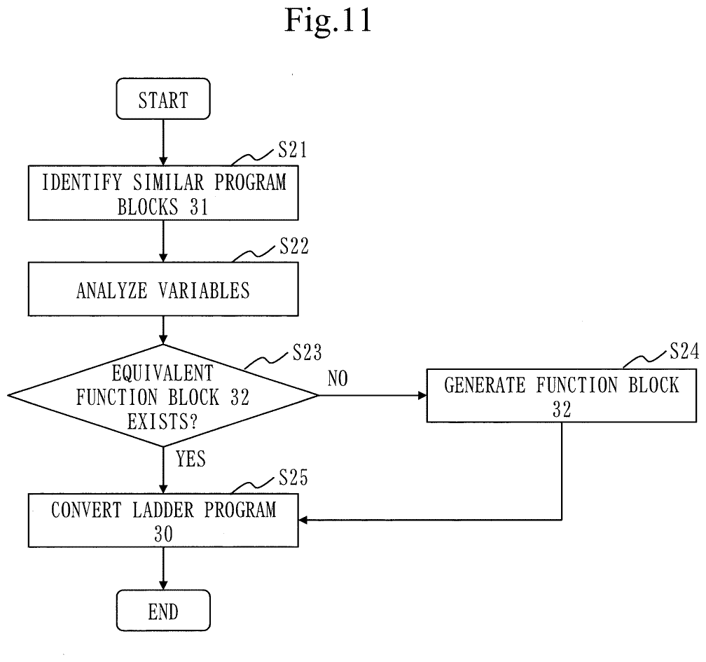

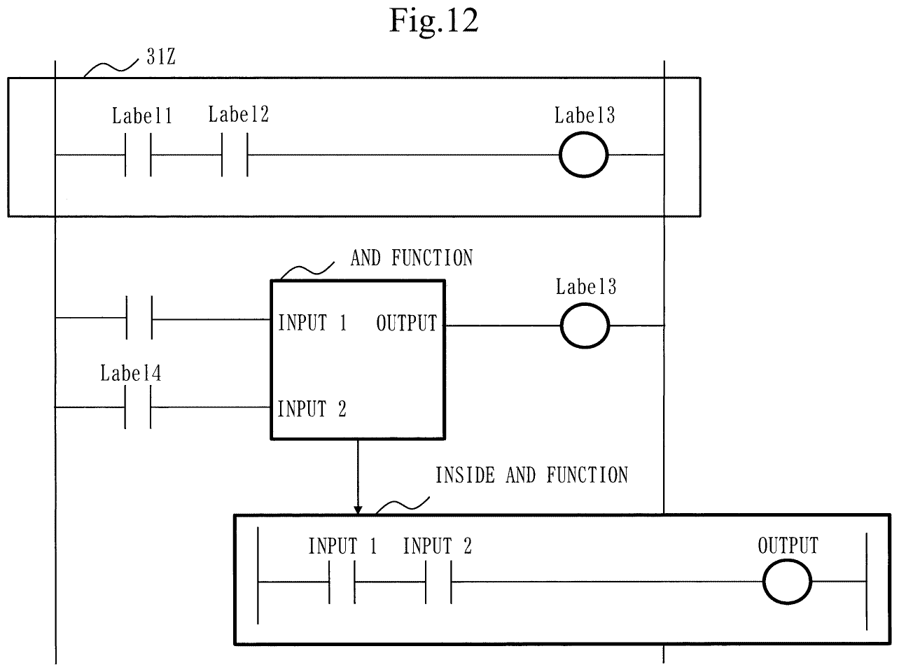

Referring to FIG. 11 and FIG. 12, an operation of the structuring support device 10 according to Embodiment 2 will be described.

An operation procedure of the structuring support device 10 according to Embodiment 2 corresponds to a structuring support method according to Embodiment 2. Also, a program that realizes the operation of the structuring support device 10 according to Embodiment 2 corresponds to a structuring support program according to Embodiment 2.

Referring to FIG. 11, a process flow of the structuring support device 10 according to Embodiment 2 will be described.

Processes from step S21 to step S22 are the same as the processes from step S11 to step S12 in FIG. 2.

### (Step S23: Program Comparison Process)

The program comparison unit 25 compares a plurality of program blocks 31 identified in step S21 with an existing function block 32. The existing function block 32 is the same as the function block 32 that was generated in the past by a function block generation unit 23, a function block 32 provided by a device manufacturer, etc.

The program comparison unit 25 determines whether or not there is an existing function block 32 with the same configuration as the plurality of program blocks 31. The same configuration as the plurality of program blocks 31 means having the same structure as the plurality of program blocks 31 and using a variable of the same type as one or more variables used in the plurality of program blocks 31. If such a function block does not exist, the program comparison unit 25 proceeds to step S24. On the other hand, if such a function block exists, the program comparison unit 25 identifies an existing function block 32 having the same configuration and then proceeds to step S25.

Referring to FIG. 12, a specific example will be described.

Here, in step S21, assume that a program block 31Z is identified as one of the plurality of program blocks 31. Also, assume that there exists an AND function to serve as an existing function block 32. The program block 31Z outputs a logical product of two inputs. Therefore, the program block 31Z has the same structure as the AND function and the same type of variable as the AND function. Thus, in the example of FIG. 12, the program comparison unit 25 judges that there is an existing function block 32 with the same structure, identifies the AND function, and proceeds to step S25.

### (Step S24: Function Block Generation Process)

The function block generation unit 23 generates a function block 32, in a similar manner to step S13 shown in FIG. 2. Then, the function block generation unit 23 writes the generated function block 32 into a storage 13 as the existing function block 32.

### (Step S25: Program Conversion Process)

A program conversion unit 24 converts a ladder program 30 by replacing the program block 31 with the existing function block 32 identified in step S23, or with the function block 32 generated in step S24.

In other words, when an existing function block 32 is identified step S23, the function block generation unit 23 discontinues generation of a function block 32 in which the plurality of program blocks 31 are common-functionalized.

### Effects of Embodiment 2

As stated above, the structuring support device 10 according to Embodiment 2 judges whether or not there is an existing function block 32 with the same configuration as the program block 31 for which the function block 32 is to be generated. If such a function block 32 exists, the structuring support device 10 will stop generation of the function block 32. As a result, generation of a plurality of equivalent function blocks 32 is prevented. Consequently, increased complexity in the structure of the converted ladder program 30 is prevented, allowing realization of efficient structuring.

Note that the term “unit” in the above explanation may be replaced with “circuit”, “stage”, “procedure”, “process”, or “processing circuitry”.

Above, the embodiments and modifications of the present disclosure have been described. It is permissible to implement some of these embodiments and modifications by combination. Furthermore, it is permissible to partially implement one or more of these embodiments and modifications. The present disclosure is not limited to the above-described embodiments and modifications, and various modifications can be made as necessary.

### REFERENCE SIGNS LIST

10: structuring support device; 11: processor; 12: memory unit; 13: storage; 14: communication interface; 21: program analysis unit; 22: variable analysis unit; 23: function block generation unit; 24: program conversion unit; 25: program comparison unit; 30: ladder program; 31: program block; 32: function block.

1. A structuring support device comprising
processing circuitry
to identify a plurality of similar program blocks contained within a ladder program, and
to set each of one or more variables used in the identified plurality of program blocks as a target variable, determine a type of the target variable in accordance with whether or not a condition is met that the target variable is not used outside the plurality of program blocks in the ladder program and is commonly used in the plurality of program blocks in the ladder program, and generate a function block obtained by functionalizing the plurality of program blocks.

2. The structuring support device according to claim 1, wherein the processing circuitry, when the condition is met, sets the type of the target variable as an internal variable, and when the condition is not met, determines the type of the target variable in accordance with in which one between an input command and an output command the target variable is being used.

3. The structuring support device according to claim 2, wherein the processing circuitry, when the condition is not met, sets the type of the target variable as an input variable if the target variable is being used in an input command and not used in an output command; sets the type of the target variable as an output function if the target variable is being used in an output command and not used in an input command; and sets the type of the target variable as an input/output variable if the target variable is being used in an input command and an output command.

4. The structuring support device according to claim 1, wherein the processing circuitry
converts the ladder program by replacing the plurality of program blocks with the generated function block.

5. The structuring support device according to claim 1,
wherein the processing circuitry identifies an existing function block having the same structure as the plurality of program blocks and using a variable of the same type as one or more variables used in the plurality of program blocks, and
wherein when an existing function block is identified, the processing circuitry discontinues generation of a function block in which the plurality of program blocks are common-functionalized.

6. The structuring support device according to claim 1,
wherein the plurality of programs are program blocks which have the same structure but use different variables.

7. A structuring support method comprising:
by a computer, identifying a plurality of similar program blocks contained within a ladder program; and
by the computer, setting each of one or more variables used in the plurality of program blocks as a target variable, determining a type of the target variable in accordance with whether or not a condition is met that the target variable is not used outside the plurality of program blocks in the ladder program and is commonly used in the plurality of program blocks in the ladder program, and generating a function block obtained by functionalizing the plurality of program blocks.

8. A non-transitory computer readable medium recorded with a structuring support program which causes a computer to function as a structuring support device that performs:
a program analysis process of identifying a plurality of similar program blocks contained within a ladder program; and
a function block generation process of setting each of one or more variables used in the plurality of program blocks identified by the program analysis process as a target variable, determining a type of the target variable in accordance with whether or not a condition is met that the target variable is not used outside a plurality of program blocks in the ladder program and is commonly used in the plurality of program blocks, and generating a function block obtained by functionalizing the plurality of program blocks.
